(19) United States
(12) Patent Application Publication
(10) Pub. No.: US 2015/0061306 A1
(43) Pub. Date: Mar. 5, 2015

(54) Cable and Outrigger for Minimizing Intrusions in a Small Offset Rigid Barrier Collision

(71) Applicant: Ford Global Technologies, LLC, Dearborn, MI (US)

(72) Inventors: Saeed David Barbat, Novi, MI (US); Ridha Baccouche, Ann Arbor, MI (US); Rahul Arora, Royal Oak, MI (US); Saied Nusier, Canton, MI (US)

(73) Assignee: Ford Global Technologies, LLC, Dearborn, MI (US)

(21) Appl. No.: 14/017,576

(22) Filed: Sep. 4, 2013

(51) Int. Cl. B60R 19/02; B62D 21/15

(52) U.S. Cl. CPC B60R 19/023; B62D 21/152; B60R 2019/026
USPC 293/124

(57) ABSTRACT

A collision countermeasure apparatus for a small offset rigid barrier test. The collision countermeasure apparatus includes a cable that is attached between an outrigger and a forward end of a frame rail assembly. The cable reduces the extent of intrusions into the passenger compartment of the vehicle.

### TECHNICAL FIELD

This disclosure relates to a cable and outrigger that are used as an energy absorbing apparatus for a vehicle that is involved in a small offset rigid barrier frontal collision.

### BACKGROUND

Land vehicles are tested for crashworthiness by a variety of tests including frontal impacts, side impacts, rear impacts, roll-over and other tests. Frontal impact tests were previously developed that specified that a vehicle impacts a barrier between the frame rails that extend longitudinally relative to the vehicle. In this type of test, the frame rails provide the primary support for the vehicle body and reduce any potential for intrusions into the passenger compartment. The extent of any intrusions into the passenger compartment are measured at the brake pedal, foot rest, left toe pan, center toe pan, right toe pan, left instrument panel, right instrument panel, and door.

A new test is proposed for simulating small offset frontal collisions against a rigid barrier. In the proposed test, the vehicle impacts a rigid barrier having a six inch pole-like radius on one corner with a 25% overlap at 40 MPH. The impact is outboard of the frame rails so that the frame rails do not provide as much resistance to intrusion into the passenger compartment as in the case of impacts between the frame rails.

The weight of land vehicles is being substantially reduced to improve fuel efficiency. Vehicles are currently being designed to reduce the weight of the vehicle with a parallel objective of not compromising performance or crashworthiness. It is difficult to meet the proposed test requirements for the small offset rigid barrier crash test while reducing vehicle weight and reducing manufacturing costs.

The above problems and other problems are addressed by this disclosure as will be summarized below.

### SUMMARY

According to one aspect of this disclosure, a collision countermeasure apparatus is provided for a vehicle comprising a cable connected between a frame rail assembly and an outrigger. The frame rail assembly extends longitudinally relative to the vehicle and has a front end. The outrigger is attached to the frame rail assembly at a location spaced from the front end. The outrigger extends laterally outwardly from the frame rail assembly to an outboard end. The cable is connected between the front end and the outboard end to reduce potential intrusions into the vehicle in a collision with a rigid barrier.

According to other aspects of this disclosure, the collision countermeasure apparatus may further include a main frame rail extending lengthwise in the vehicle and is spaced from a side of the vehicle. The frame rail may be partially disposed below a passenger compartment and may further include a frame rail extension that includes the front end. The collision countermeasure apparatus may further comprise a connection point where the main frame rail is joined to the frame rail extension. An inner end of the outrigger may be attached to the frame rail assembly adjacent the connection point.

The cable may form a triangular deflector with the outrigger and a portion of the frame rail assembly forward of the outrigger. In addition, the collision countermeasure apparatus may also comprise a mounting bracket that attaches the outrigger to the frame rail assembly.

According to another aspect of this disclosure a method is disclosed for reducing intrusions into a passenger compartment of a vehicle in a collision with a rigid barrier. The vehicle includes a bumper beam, a frame rail assembly, an outrigger attached to and extending outwardly from the frame rail and a cable connected between a front end of the frame rail assembly and an outer end of the outrigger. The method comprises colliding with the rigid barrier that engages the bumper beam at a location laterally outboard of the frame rail assembly. The rigid barrier is impacted by the cable that receives an impact force and distributes the impact force through the cable to the frame rail assembly and the outrigger.

According to another aspect of the method, the vehicle may be moved away from the rigid barrier in reaction to the rigid barrier impacting the cable as the vehicle slides in a forward direction along the cable.

According to other aspects of this disclosure, the method may further comprise bending the frame rail assembly in a laterally outboard direction as a reaction to the rigid barrier impacting the cable. The method may also include driving the outer end of the outrigger in a rearward direction as a reaction to the rigid barrier impacting the cable.

The method may further comprise joining the outrigger to the frame rail assembly at a connection point between the main frame rail and the frame rail extension. An inner end of the outrigger is attached to the frame rail assembly adjacent the connection point. The cable forms a triangular deflector with the outrigger and a portion of the frame rail assembly forward of the outrigger. The method may further comprise providing a bracket that is attached to the outrigger and the frame rail assembly.

According to another aspect of this disclosure, a front end of a vehicle is disclosed that includes a frame rail assembly, an outrigger and a cable. The frame rail assembly extends longitudinally and has a forward end. The outrigger is attached to a frame rail assembly at a location that is spaced from the forward end and extends outwardly in a lateral direction from the frame rail assembly to an outboard end. The cable is connected between the forward end and the outboard end to provide a countermeasure for a collision with a rigid barrier.

According to another aspect of this disclosure as it relates to a front end of a vehicle, the frame rail assembly may include a main frame rail extending lengthwise in the vehicle at a location inboard of a side of the vehicle and that is partially disposed below a passenger compartment. The frame rail assembly may further include a frame rail extension that includes a forward end. The main frame rail is joined at a connection point to the frame rail extension. An inner end of the outrigger may be attached to the frame rail assembly adjacent the connection point.

The above aspects and other aspects of this disclosure will be described in greater detail below with reference to the attached drawings.

### BRIEF DESCRIPTION OF THE DRAWINGS

FIG. 1 is a fragmentary bottom plan view of one side of a front end of a vehicle having a collision countermeasure apparatus including a cable connected between the bumper beam of a vehicle and a transversely extending rigid outrigger.

FIG. 2 is a fragmentary perspective view of one side of a front end of a vehicle having a collision countermeasure apparatus including a cable connected between the bumper beam of a vehicle and the outrigger as shown in FIG. 1.

FIG. 3 is a fragmentary bottom plan view of one side of a front end of a vehicle having the collision countermeasure apparatus shown in FIGS. 1 and 2 after a simulated test showing a collision with a rigid barrier conducted in accordance with a small offset rigid barrier test.

FIG. 4 is a graph of a small offset rigid barrier test report comparing the extent of intrusion into the passenger compartment of a vehicle in a simulated small offset rigid barrier test testing a base model vehicle including the disclosed cable and outrigger collision countermeasure apparatus.

### DETAILED DESCRIPTION

A detailed description of the illustrated embodiments of the present invention is provided below. The disclosed embodiments are examples of the invention that may be embodied in various and alternative forms. The figures are not necessarily to scale. Some features may be exaggerated or minimized to show details of particular components. The specific structural and functional details disclosed in this application are not to be interpreted as limiting, but merely as a representative basis for teaching one skilled in the art how to practice the invention.

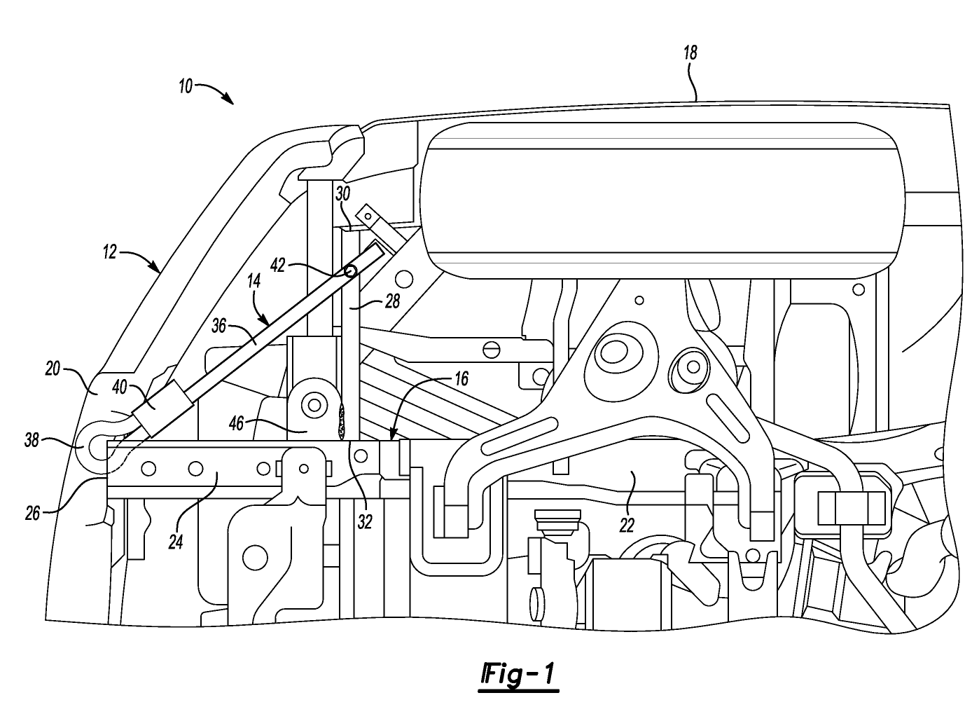

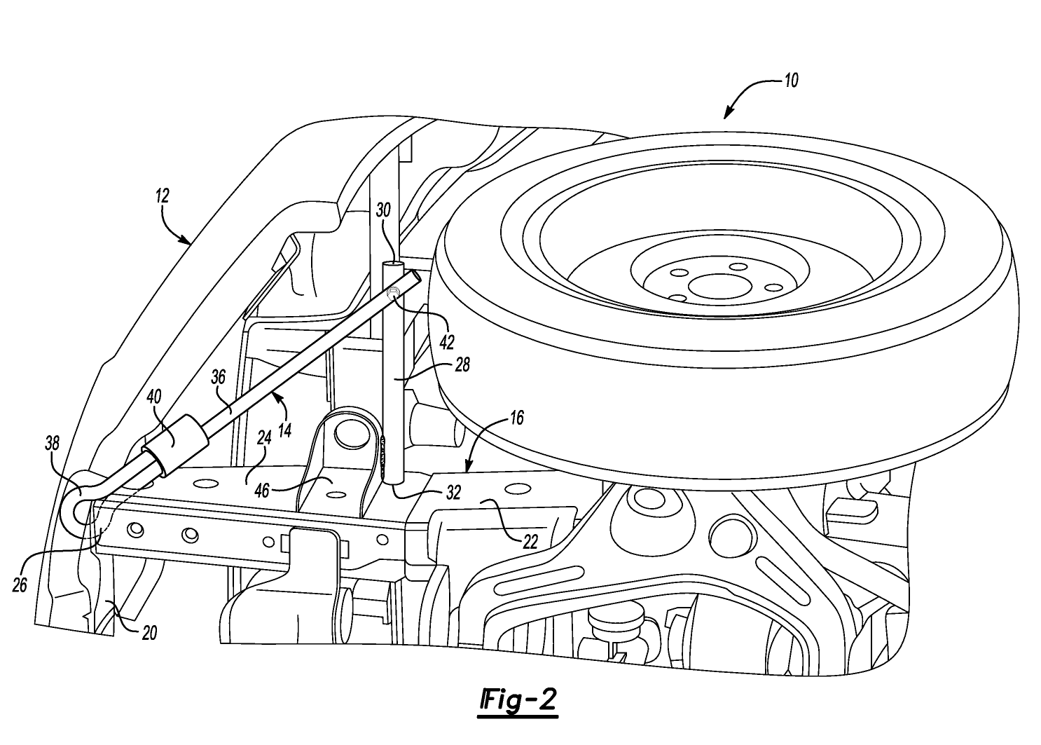

FIGS. 1 and 2 show a vehicle 10, in particular a front end 12 of the vehicle 10, that is equipped with a collision countermeasure apparatus generally indicated by reference numeral 14. The collision countermeasure apparatus 14 includes a frame rail assembly 16 that extends in the longitudinal direction or in the direction of travel of the vehicle 10. The frame rail assembly 16 is spaced inboard from the side 18 of the vehicle 10. The frame rail assembly 16 functions to support and back up the bumper beam 20.

The frame rail assembly 16 includes a main frame rail 22 and a frame rail extension 24. A forward end 26 of the frame rail assembly 16 is provided on the frame rail extension 24.

An outrigger 28 is attached to the frame rail assembly 16 at a location adjacent to the location where the frame rail extension 24 is connected to the frame rail 22. The outrigger 28 is preferably formed from a strong rigid material, for example a boron steel 1300 alloy, or the like. The outrigger 28 has an outboard end 30 that is outboard of the frame rail assembly 16 and an inner end 32 that is welded or otherwise secured to the frame rail assembly 16.

A cable 36 is connected between the forward end 26 of the frame rail extension 24 and the outboard end 30 of the outrigger 28. The cable 36 may include a bight 38, or reversely turned portion, that is secured by a cable clamp 40 to the frame rail extension 24. The cable 36 is shown secured by a fastener 42 to the outboard end 30 of the outrigger 28. The cable 36 may be secured by cable clamps 40 or fasteners 42 at one or both ends.

A bracket 46 may be secured to the frame rail extension 24 and the outrigger 28. The outrigger 28 may be welded to the bracket 46.

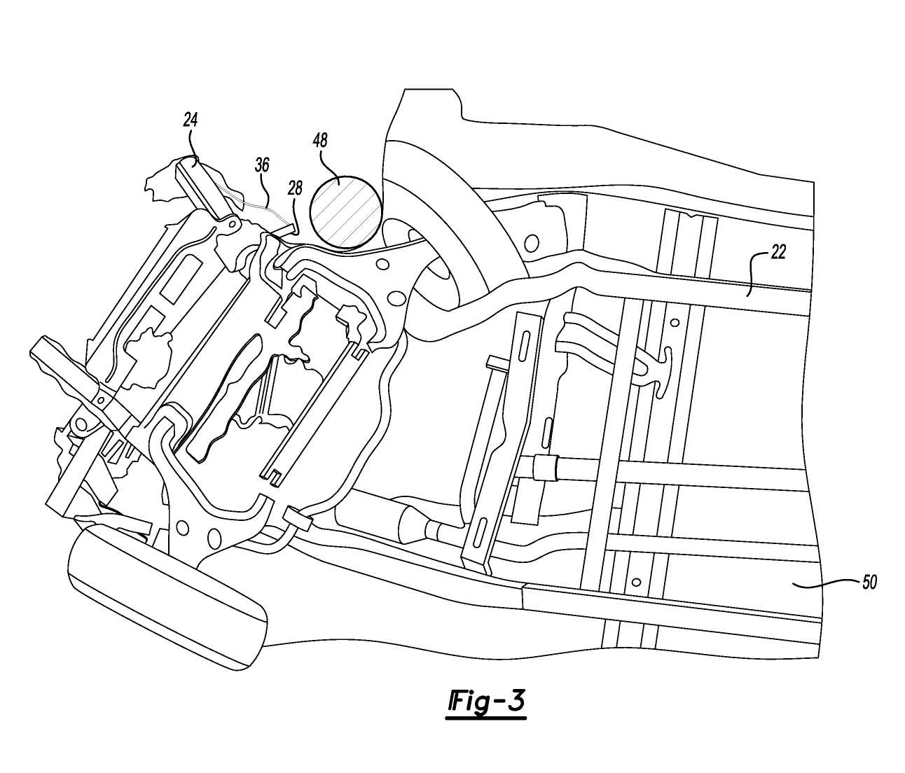

Referring to FIG. 3, the vehicle 10 is shown after a collision with a rigid barrier 48, such as a cylindrical post-like barrier. The vehicle is shown after the outer portion of a bumper beam 20 (shown in FIGS. 1 and 2) collides with the rigid barrier 48. The vehicle continues to move forward with the rigid barrier 48 contacting the cable 36. The vehicle continues to move forward until it passes the outrigger 28 to the position shown in FIG. 3. Depending upon the severity of the collision, the rigid barrier 48 may penetrate through the vehicle to a greater or lesser extent.

When the rigid barrier 48 is engaged by the cable 36, the cable distributes the impact force to the frame rail extension 24 and the frame rail 22. The force of the collision is transferred by the outrigger 28 to the main frame rail 22. The vehicle 10 may be laterally displaced when the cable 36 contacts the rigid barrier 48. The frame rail extension 24, outrigger 28 and cable 36 are arranged in a triangular configuration with the cable 36 providing a strong, flexible link between forward end 26 of the frame rail extension 24 and the outboard end of the outrigger 28. When the rigid barrier 48 contacts the generally diagonally oriented cable 36, the vehicle 10 may be forced laterally away from the rigid barrier 48. The main frame rail 22 extends below the passenger compartment 50 of the vehicle 10.

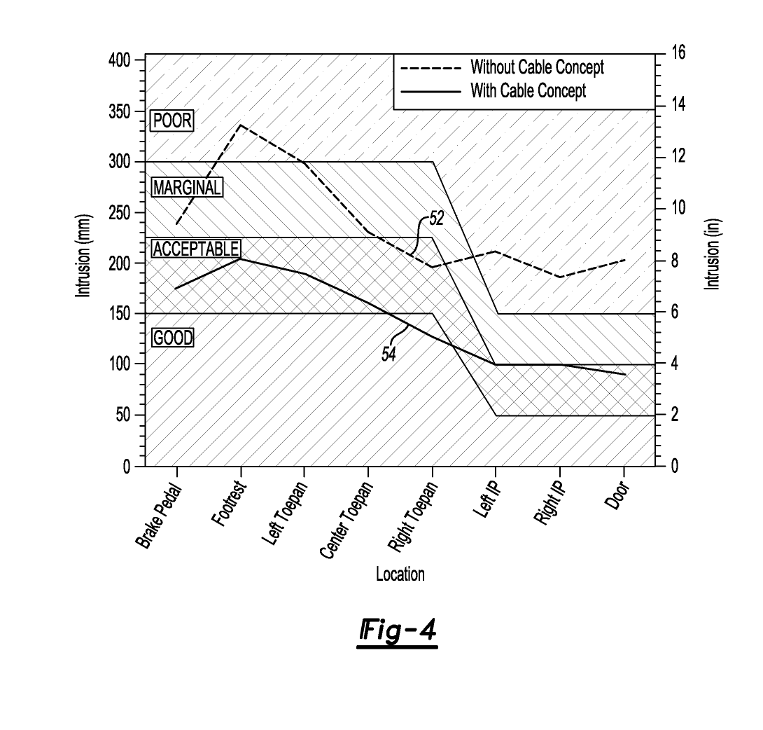

Referring to FIG. 4, a graph is provided of a simulation of a small offset rigid barrier test. A base model vehicle shown by line 52 is compared to an identical vehicle shown by line 54, but that includes the cable and outrigger that is attached to the main frame rail assembly.

Comparing line 52 to line 54, improvements in reducing intrusion are apparent in every location. A substantial improvement in performance is shown at the foot rest where the extent of intrusion is reduced from 340 mm to 210 mm. At the left toe pan, the improvement is from 300 mm to 180 mm. At the left instrument panel, intrusion was reduced from 240 mm to 100 mm and at the right toe pan the extent of intrusion improved from 108 mm to 100 mm. At the door, the extent of intrusion was reduced from 200 mm to 90 mm. In all cases, the extent of improvement from the base model shown by line 52 improved from a poor or marginal rating generally to an acceptable rating, as shown by line 54.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A collision countermeasure apparatus for a vehicle comprising:
a frame rail assembly extending longitudinally and having a front end;
an outrigger attached to the frame rail assembly spaced from the front end and extending outwardly and transversely from the frame rail assembly to an outboard end; and
a cable connected between the front end and the outboard end for reducing an extent of intrusion into the vehicle in a collision with a rigid barrier.

2. The collision countermeasure apparatus of claim 1 wherein the frame rail assembly includes a main frame rail extend lengthwise in the vehicle spaced from a side of the vehicle and is partially disposed below a passenger compartment, and wherein the frame rail assembly further includes a frame rail extension that includes the front end.

3. The collision countermeasure apparatus of claim 2 further comprising a connection point where the main frame rail is joined to the frame rail extension, and wherein an inner end of the outrigger is attached to the frame rail assembly adjacent the connection point.

4. The collision countermeasure apparatus of claim 1 wherein the cable forms a triangular deflector with the outrigger and a portion of the frame rail assembly forward of the outrigger.

5. The collision countermeasure apparatus of claim 1 further comprising a bracket that attaches the outrigger to the frame rail assembly.

6. A method of reducing intrusions into a passenger compartment of a vehicle in a collision with a rigid barrier, wherein the vehicle includes a bumper beam, a frame rail assembly, an outrigger attached to and extending outwardly from the frame rail and a cable connected between a front end of the frame rail assembly and an outer end of the outrigger, the method comprising:
colliding with the rigid barrier that engages the bumper beam at a location laterally outboard of the frame rail assembly;
impacting the rigid barrier with the cable that receives an impact force; and
distributing the impact force through the cable to the frame rail assembly and the outrigger.

7. The method of claim 6 further comprising:
moving the vehicle away from the rigid barrier as a reaction to the rigid barrier impacting the cable as the vehicle slides in a forward direction along the cable.

8. The method of claim 6 further comprising:
bending the frame rail assembly in a laterally outboard direction as a reaction to the rigid barrier impacting the cable.

9. The method of claim 6 further comprising:
bending the frame rail assembly in a laterally outboard direction; and
driving the outer end of the outrigger in a rearward direction as a reaction to the rigid barrier impacting the cable.

10. The method of claim 6 wherein the frame rail assembly includes a main frame rail extend lengthwise in the vehicle spaced from a side of the vehicle and is partially disposed below the passenger compartment, and wherein the frame rail assembly further includes a frame rail extension that includes the front end.

11. The method of claim 10 further comprising a connection point where the main frame rail is joined to the frame rail extension, and wherein an inner end of the outrigger is attached to the frame rail assembly adjacent the connection point.

12. The method of claim 6 wherein the cable forms a triangular deflector with the outrigger and a portion of the frame rail assembly forward of the outrigger.

13. The method of claim 6 further comprising a bracket that attaches the outrigger to the frame rail assembly.

14. A front end of a vehicle comprising:
a frame rail assembly extending longitudinally and having a forward end;
an outrigger attached to the frame rail assembly spaced from the forward end and extending outwardly and laterally from the frame rail assembly to an outboard end; and
a cable connected between the forward end and the outboard end to provide a countermeasure for a collision with a rigid barrier.

15. The front end of a vehicle of claim 14 wherein the frame rail assembly includes a main frame rail extend lengthwise in the vehicle spaced from a side of the vehicle and is partially disposed below a passenger compartment, and wherein the frame rail assembly further includes a frame rail extension that includes the forward end.

16. The front end of a vehicle apparatus of claim 15 further comprising a connection point where the main frame rail is joined to the frame rail extension, and wherein an inner end of the outrigger is attached to the frame rail assembly adjacent the connection point.

17. The front end of a vehicle of claim 14 wherein the cable forms a triangular deflector with the outrigger and a portion of the frame rail assembly in front of the outrigger.

18. The front end of a vehicle of claim 14 further comprising a bracket that attaches the outrigger to the frame rail assembly.
